(19) United States
(12) Patent Application Publication
(10) Pub. No.: US 2016/0063853 A1
(43) Pub. Date: Mar. 3, 2016

(54) PERSONALIZED HOME SITUATION CONTROL SYSTEM AND PERSONALIZED HOME SITUATION CONTROL METHOD

(71) Applicant: Tsung-Hsiang MI, Taoyuan County (TW)

(72) Inventor: Tsung-Hsiang MI, Taoyuan County (TW)

(21) Appl. No.: 14/469,415

(22) Filed: Aug. 26, 2014

(51) Int. Cl. G08C 17/02

(52) U.S. Cl. CPC G08C 17/02; G08C 2201/92; G08C 2201/30

(57) ABSTRACT

A personalized home situation control system has a personalized situation control device, and at least one repeating device and at least one sensing device located in an environment of multiple users. The situation control device serves for editing a situation list. Each one of the at least one repeating device is connected to an electric appliance module capable of changing atmosphere in the environment, receives commands transmitted from the situation control device, and controls an operating state of the electric appliance. When activated by the situation control device, multiple electric appliance modules in the environment can be controlled by corresponding repeating devices, which are instructed by corresponding sensing devices, according to the situation list. Accordingly, the situation control device can be used to generate an editable and personalized home situation effect in a portable and less environmentally restrictive manner, thereby enhancing operational convenience and flexibility.

### BACKGROUND OF THE INVENTION

1. Field of the Invention

The present invention relates to a control system and a method and, more particularly, to a system and a method for different home members to control home electric appliances at personalized operating states of the home electric appliances preferred by the home members.

2. Description of the Related Art

Technological progress urges the need of people in pursuit of home electric appliances having operational convenience and efficiency in everyday domestic life. Specifically, all electric appliances within a home environment can be wirelessly controlled or can communicate with each other. Electric appliances in daily life of people generally include lighting system, temperature control system, media player system, surveillance system, biometric identification system, and the like. The most common conventional control means over those electric appliances is performed through an infrared transceiver. However, such control means is prone to blockage due to obstruction in the path of transmission and causes inconvenience to people who need to frequently control the electric appliances distributed in a large spacious environment.

As disclosed in a Taiwan utility model patent M376076, entitled “Multiplex integrated remote control system and multiplex remote control device, a multiplex integrated remote control device is provided to activate all home electric appliances or adjust the electric appliances at desired operating conditions, supports the wireless protocol ZigBee to remotely control multiple electric appliances in an environment through a ZigBee-based network, and has a housing, a storage module, an key input module and a microprocessor module. The storage module is mounted inside the housing. The key input module is mounted on the housing. The microprocessor is mounted inside the housing and is electrically connected to the storage module and the key input module.

The microprocessor module has a binding unit, a control unit, a situation-storing unit and a situation-recovering unit. The binding unit binds a specific function of a preset electric appliance. The control unit remotely controls the preset electric appliance to perform the specific function thereof. The situation-storing unit stores current operating states of all electric appliances bound by the binding unit. The situation-recovering unit drives the control unit to restore the operating states of all the electric appliances bound by the binding unit to the operating states as stored in the situation-storing unit.

Although the foregoing multiplex integrated remote control device resolves the interference issue arising from obstruction in the path of signal transmission of an infrared transceiver and provides the key input module to input commands to restore electric appliances to the stored operating states of the electric appliances, the control effect provided by the multiplex integrated remote control device is quite limited as far as the fixed effect that stores states of functions of the electric appliances for users to retrieve the stored operating states in operation is concerned. Additionally, for users frequently moving around in a spacious home environment, relocating electric appliances in the environment, or having different setting preferences of the electric appliances, the foregoing binding means causes confusion, troubles or even conflict among all members in the family.

### SUMMARY OF THE INVENTION

An objective of the present invention is to provide a personalized home situation control method and system for all members in a family to create personalized atmosphere out of operating conditions of multiple electric appliances in a home environment adjusted in a portable and less environmentally restrictive manner through wireless communication and sensing.

To achieve the foregoing objective, the personalized home situation control method is performed by a situation control device to vary operating states of multiple electric appliance modules capable of changing atmosphere or condition in an environment through at least one wireless communication protocol, and the method has steps of:

receiving wireless signals transmitted from the multiple electric appliance modules;

providing a situation-editing interface for users to select information represented by the wireless signals from the situation-editing interface to define at least one situation list, wherein each one of the at least one situation list has a preset identification code;

determining if a situation mode execution command is received; and

wirelessly transmitting control signals to corresponding electric appliance modules for the corresponding electric appliance modules to perform corresponding operation according to contents of the at least one situation list in generation of a personalized home situation effect.

From the foregoing personalized home situation control method, users can utilize the situation control device to receive wireless signals transmitted from multiple electric appliance modules, and define contents of a personalized situation list and a identification code corresponding to the situation list on the situation-editing interface. When users go through the situation control device to input a situation mode execution command, the situation control device then wirelessly transmits a control signal to corresponding electric appliance modules for the corresponding electric appliance modules to change operating states according to the contents of the situation list in generation of a personalized home situation effect in a portable and less environmentally restrictive manner, thereby enhancing operational convenience and flexibility upon delivering the personalized home situation effect.

To achieve the foregoing objective, the personalized home situation control system has a situation control device, at least one repeating device and at least one sensing device.

The situation control device has a first wireless module, a second wireless module and an operation interface.

The operation interface serves for multiple users to define multiple personalized situation lists and identification codes corresponding to the personalized situation lists, and wirelessly communicates with an remote equipment for data exchange respectively through the first wireless module and the second wireless module.

Each one of the at least one repeating device has a third wireless module, at least signal input terminal and at least one signal input terminal.

Each one of the at least one signal output terminal is electrically connected to an electric appliance module capable of changing atmosphere in an environment and is wirelessly connected to the first wireless module of the situation control device through the third wireless module.

Each one of the at least one sensing device has a fourth wireless module and a fifth wireless module.

The fourth wireless module serves for the sensing device to transmit a sensing mode signal through the fourth wireless module to the second wireless module of the situation control device.

The fifth wireless module serves for the sensing device to wirelessly connect to the third wireless module of a corresponding repeating device through the fifth wireless module.

From the foregoing personalized home situation control system, the personalized situation control device allows users to edit personalized situation lists and identification codes corresponding to the situation lists through the operation interface, employs the first wireless module and the second wireless module to wirelessly connect to the at least one repeating device and corresponding sensing devices in an environment where the users are located for wireless communication and data exchange. Each one of the at least one repeating device is electrically connected to at least one electric appliance module capable of changing atmosphere of the environment and control operating states of the at least one electric appliance module according to the contents of the situation list. When the users move to a different environment with multiple electric appliance modules, the situation control device can receive the sensing mode signals transmitted from the corresponding sensing device, activate the corresponding sensing device to wirelessly communicate with the third wireless module of the repeating device through the fifth wireless module of the sensing device such that the sensing device instructs the repeating device to change the operating states of the electric appliance modules according to the contents of the situation list in generation of a personalized home situation effect. Accordingly, the situation control device can be adopted to generate an editable and personalized home situation effect in a portable and less environmentally restrictive manner, thereby enhancing operational convenience and flexibility upon delivering the personalized home situation effect.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a first embodiment of a personalized home situation control system in accordance with the present invention;

FIG. 2 is a functional block diagram of the personalized home situation control system in FIG. 1;

FIG. 3 is a schematic diagram of an implementation using the personalized home situation control system in FIG. 1;

FIG. 4 is a functional block diagram of a second embodiment of a personalized home situation system in accordance with the present invention;

FIG. 5 is a flow diagram of a personalized home situation control method operated under an operating mode in accordance with the present invention; and

FIG. 6 is a flow diagram of a personalized home situation control method operated under a sensing mode in accordance with the present invention.

### DETAILED DESCRIPTION OF THE INVENTION

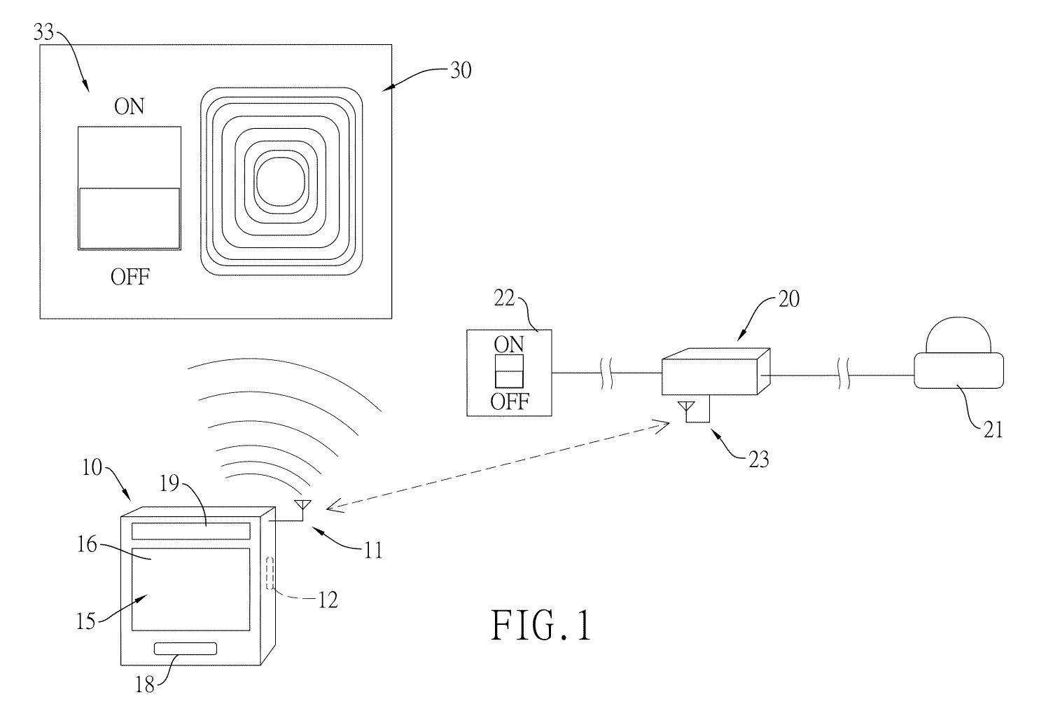

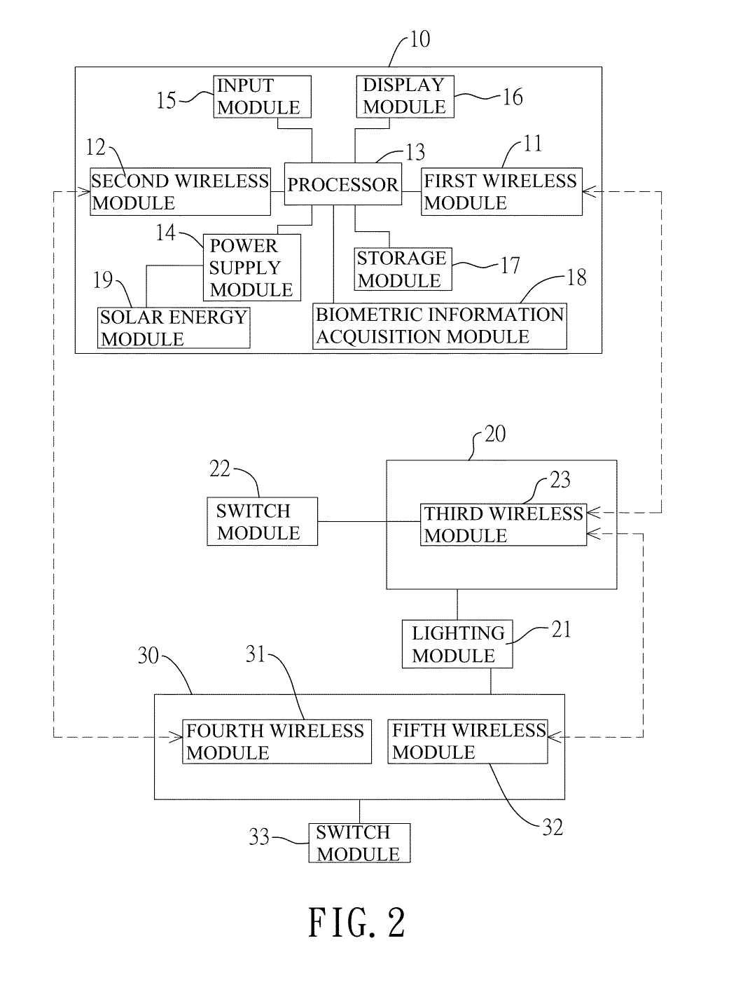

With reference to FIGS. 1 and 2, a personalized home situation control system in accordance with the present invention has a situation control device 10, at least one repeating device 20 and at least one sensing device 30. The situation control device 10 is portable, wirelessly communicates with external equipment to exchange data therewith through at least one wireless protocol, and has an operation interface. The operation interface serves for users to define a personalized situation list and an identification code corresponding to the situation list. Each one of the at least one repeating device 20 is connected to an electric appliance capable of changing atmosphere or condition in a surrounding environment, and may be a lighting module, a media player module, a broadcasting module, an air-conditioning module, an electric curtain module and the like. In the present embodiment, each one of the at least one repeating device 20 is connected to an electric appliance module to connect or disconnect power of a power supply to or from the electric appliance module. The electric appliance module has a lighting module 21 and a switch module 22. The repeating device 20 wirelessly receives a command transmitted from the situation control device 10 through a wireless protocol to control an operating condition of the electric appliance module. The situation control device 10 wirelessly activates the sensing device 30 through another wireless protocol for the sensing device 30 to instruct the repeating device 20 to control the operating condition of the electric appliance module.

The situation control device 10 has a housing, a first wireless module 11 and a second wireless module 12. The housing takes the form of a business card. The operation interface of the situation control device 10 wirelessly communicates with the repeating device 20 and the sensing device 30 respectively through a first wireless module 11 and a second wireless module 12 for data exchange. The first wireless module 11 and the second wireless module 12 respectively comply with a first wireless protocol and a second wireless protocol. In the present embodiment, the situation control device 10 further has a processor 13, a power supply module 14 and a storage module 17 mounted inside the housing and an input module 15, a display module 16, a biometric information acquisition module 18 and a solar energy module 19 mounted on the housing. The processor 13 is electrically connected to the power supply module 14, the input module 15, the display module 16, the storage module 17 and the biometric information acquisition module 18. The power supply module 14 is electrically connected to the solar energy module 19.

The power supply module 15 serves to supply an operating power to the situation control device 10. The solar energy module 19 serves to receive solar energy and output electrical energy to the power supply module 14. The input module 15 serves for users to input the self-defined personalized situation list and the identification code. The display module 16 serves to display relevant information inputted by users for users to view. The input module 15 and the display module 16 constitute the operation interface of the situation control device 10. The storage module 17 stores the personalized situation lists, the identification codes and related information dedicated to multiple users. The biometric information acquisition module 18 receives biometric information and stores the biometric information in the storage module 17 for information security and confidentiality. When the situation control device 10 is intended for use, the processor 13 goes through the biometric information acquisition module 18 to receive biometric information of a user and then compares the biometric information with that pre-stored in the storage module 17 to authenticate if the user has the privilege for operation.

With reference to FIG. 2, the repeating device 20 has at least one signal input terminal, at least one signal output terminal and a third wireless module 23. One of the at least one signal input terminal is connected to the switch module 22. One of the at least one signal output terminal is electrically connected to the lighting module 21. The third wireless module 23 establishes a wireless connection to the first wireless module using the first wireless protocol. When users perform an operation mode command on the operation interface, the repeating device 20 receives a control signal wirelessly transmitted from the situation control device 10 for the lighting module 21 to generate a corresponding variation in luminance. In the present embodiment, the first wireless protocol is the ZigBee protocol.

The sensing device 30 has a fourth wireless module 31, a fifth wireless module 32 and a switch module 33. The fourth wireless module 31 establishes a wireless connection to the second wireless module 12 using the second wireless protocol, sends a sensing mode signal to the second wireless module 12 of the situation control device 10 for the fifth wireless module 32 to wirelessly connect to the third wireless module 23 of the repeating device 20 using the first wireless protocol. Users can use the situation control device 10 to activate the sensing device 30 for the sensing device 30 to instruct the repeating device 20 to control an operating condition of the electric appliance module according to contents of the situation list. In the present embodiment, the second wireless protocol is the RFID protocol.

The foregoing personalized home situation control system provides the situation control device 10 for editing personalized situation list and identification code dedicated to a user through the operation interface. Wireless communication and data exchange between the situation control device 10 and the repeating device 20 and between the repeating device 20 and the sensing device 30 can be performed through the first wireless protocol. The operation conditions of the electric appliance modules are adjusted according to the contents of the situation list. For an environment with multiple repeating devices 20 and multiple electric appliance modules, the situation control device 10 receives the sensing mode signal transmitted from the sensing device 30, communicates with the repeating device 20 through the sensing device 30, and instructs the repeating devices 20 to vary the operation conditions of the respective electric appliance modules to generate a personalized home situation effect, achieve portability and enhance operational convenience and flexibility.

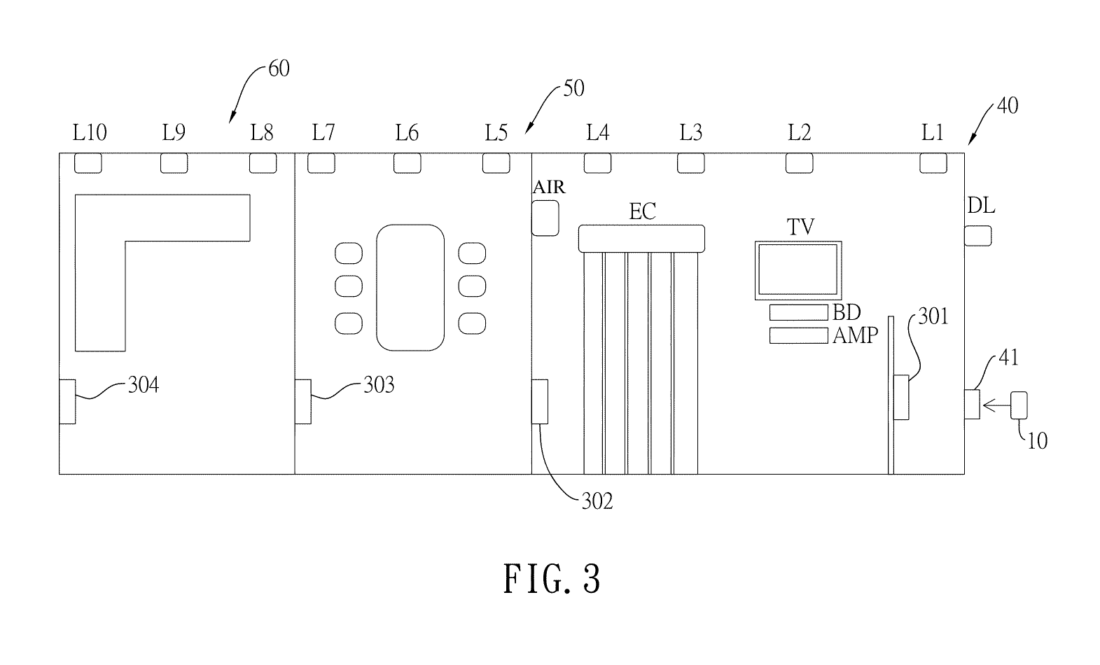

With reference FIG. 3, a venue where the personalized home situation system is installed is shown is shown and has a first activity area 40, a second activity area 50 and a third activity area 60. The first activity area 40, the second activity area 50 and the third activity area 60 are partitioned and are next to each other sequentially, and each of them has multiple repeating devices 20, multiple electric appliance modules and multiple sensing devices 30 mounted therein. The multiple electric appliance modules include ten lamps indicated by a first lamp to a tenth lamp L1˜L10, an air conditioner AIR, a television TV, a media player BD, an amplifier equipment AMP and an electric curtain EC. The first lamp to the fourth lamp L1˜L4, the air conditioner AIR, the television TV, the media player BD, the amplifier equipment AMP and the electric curtain EC are mounted inside the first activity area. The fifth lamp to the seventh lamp L5˜L7 are mounted inside the second activity area. The eighth lamp to the tenth lamp L8˜L10 are mounted inside the third activity area. The multiple sensing devices 30 include four sensing devices indicated by a first sensing device to a fourth sensing device 301˜304.

The first activity area 40 has an entrance. A sensor lock 41 and a door lamp DL are mounted outside the entrance. A first sensing device 301 is mounted at the entrance hallway. A second sensing device 302 is mounted at a place in the first activity area where is opposite to the entrance. The second sensing device 302 is mounted inside the first activity area 40 and corresponds to the first lamp to the fourth lamp L1˜L4, the air conditioner AIR, the television TV, the media player BD, the amplifier equipment AMP and the electric curtain EC. The third sensing device 303 is mounted inside the second activity area 50 and corresponds to the fifth lamp to the seventh lamp L5˜L7. The fourth sensing device 304 is mounted inside the third activity area 60 and corresponds to the eighth lamp to the tenth lamp L8˜L10.

When a user enters the first activity area with the situation control device 10, the user can use the situation control device 10 to turn on the door lamp DL and put his/her fingers on the situation control device 10 for fingerprint scan such that the biometric information acquisition module 18 transmits the personal biometric information of the user to the processor 13 for identity authentication to ensure a confidentiality-guarantee mechanism with information security. After the identity of the user is correctly authenticated, the user can move the situation control device 10 close to the sensor lock 41 to open the door of the entrance, and the door lamp DL can be configured to automatically turn off after the door is opened.

After the user enters the first activity area 40, the user can move the situation control device 10 close to the first sensing device for the first sensing device to receive a sensing signal and perform a welcoming situation mode in the situation list of the situation control device 10 dedicated to the user. Alternatively, the welcoming situation mode can be directly performed by choosing the welcoming situation mode on the operation interface of the situation control device 10. The situation control device 10 then instructs all the repeating devices 20 to control corresponding electric appliance modules. When the welcoming situation mode starts, the electric curtain EC is changed from a closed state to an open state, the first lamp L1 and the fourth lamp L4 are turned on with 50% of their full luminance, the second lamp L2 and the third lamp L3 are turned on with their full luminance, the air conditioner is turned on at 25° C., and the television TV, the amplifier equipment AMP are turned on with a preset channel playing in the television TV.

If the situation list also contains a movie situation mode and the user intends to change the welcoming situation mode to the move situation mode, the user just needs to move the situation control device 10 close to the second sensing device 302 for the second sensing device 302 to receive a sensing signal and perform the movie situation mode in the situation list of the situation control device 10 dedicated to the user. Similarly, the movie situation mode or any other situation mode in the situation list can be directly performed by choosing it on the operation interface of the situation control device 10. When the movie situation mode starts, the electric curtain EC is changed from the open state to the closed state, the first lamp L1 and the fourth lamp L4 is adjusted at 30% of their full luminance, the second lamp L2 and the third lamp L3 are adjusted at half of their full luminance, the television TV is switched to a HDMI channel with the media player BD corresponding to the HDMI channel of the television TV, and the amplifier equipment AMP is switched to mode appropriate to the media player BD with a preset volume at 20 dB.

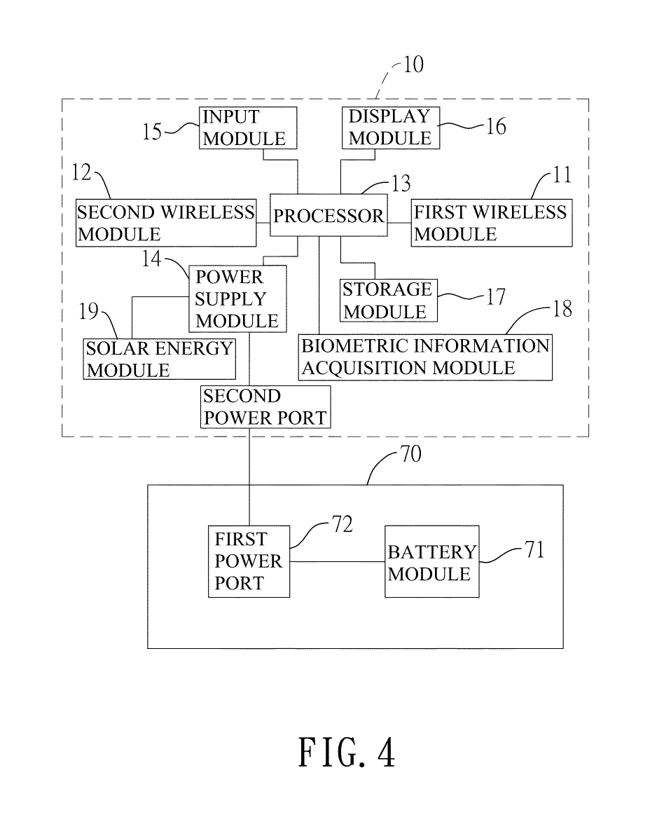

With reference to FIG. 4, a second embodiment of a personalized home situation control system in accordance with the present invention has a situation control device 10 and a mobile device 70. The mobile device 70 has a battery module 71 and a first power port 72. The battery module 71 is electrically connected to the first power port 72. The situation control device 10 differs from that of the foregoing embodiment in further having a second power port 141. The second power port 141 of the situation control device 10 is electrically connected to the first power port 72 of the mobile device 70 such that the battery module 71 of the mobile device 70 can supply power to the situation control device 10 and the power supply module 14 of the situation control device 10 can charge the battery module 71 of the mobile device 70. The solar energy module 19 of the situation control device 10 can convert solar energy into electrical energy and further charge the battery module 71 of the mobile device 70.

The situation control device 10 is further connected to a voice collecting device for the purpose of voice-activated control. If users intend to perform one of the foregoing situation modes on the situation control device 10, the voice collecting device serves to receive a voice control command to activate the situation mode, such as the movie situation mode, and may be a microphone. Furthermore, the sensing device 30 is further connected to an announcing device featured by voice prompting function. After a situation mode in the situation list is successfully performed, the announcing device will broadcast a voice prompt, such as “You have performed No. 1 movie situation mode”, to remind users.

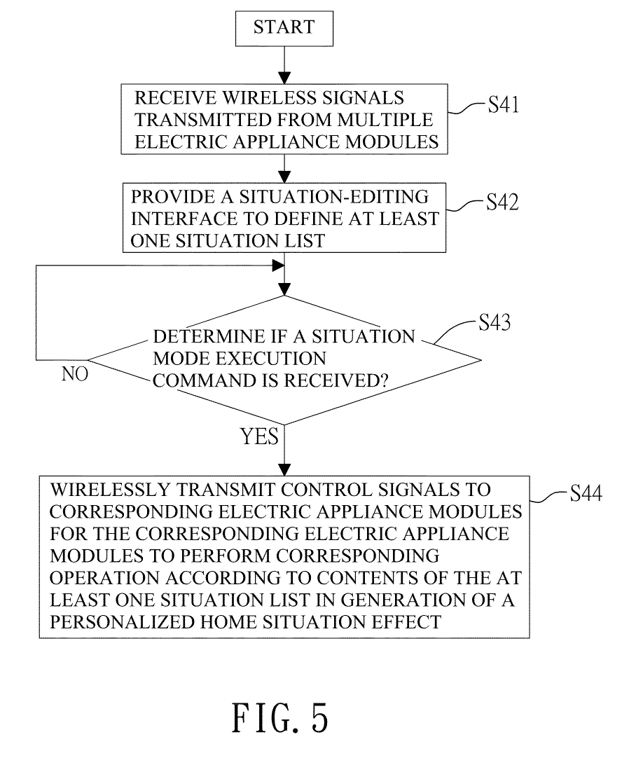

A personalized home situation control method in accordance with the present invention can be concluded from the foregoing embodiments and is performed by the foregoing situation control device to control environmental atmosphere or conditions provided by multiple electric appliance modules in a home environment through at least one wireless protocol. With reference to FIG. 5, the personalized home situation control method has the following steps.

Step S41: Receive wireless signals transmitted from multiple electric appliance modules to locate all the electric appliance modules in all activity areas 40, 50, 60. The electric appliance modules transmit the wireless signals through the foregoing repeating devices 20.

Step S42: Provide a situation-editing interface as an operation interface to select information represented by the wireless signals from the situation-editing interface to define at least one situation list. Each one of the at least one situation list has a preset identification code.

Step S43: Determine if a situation mode execution command is received. When the situation mode execution command is not received, resume step S43.

Step S44: Wirelessly transmit control signals to corresponding electric appliance modules for the corresponding electric appliance modules to perform corresponding operation, such as luminance adjustment, sound volume adjustment, and the like, according to contents of the at least one situation list in generation of a personalized home situation effect.

Users can use the situation control device 10 to wirelessly receive control signals transmitted from multiple electric appliance modules within a signal-receiving range and further through the repeating device 20, and define contents and a preset identification code of a situation list on the situation-editing interface of the situation control device 10. When users input a situation mode execution command from the situation control device 10, a control signal is wirelessly transmitted to a corresponding electric appliance module such that the multiple electric appliance modules perform operation to change atmosphere and conditions in the environment according to the contents in the situation list in generation of a personalized home situation effect.

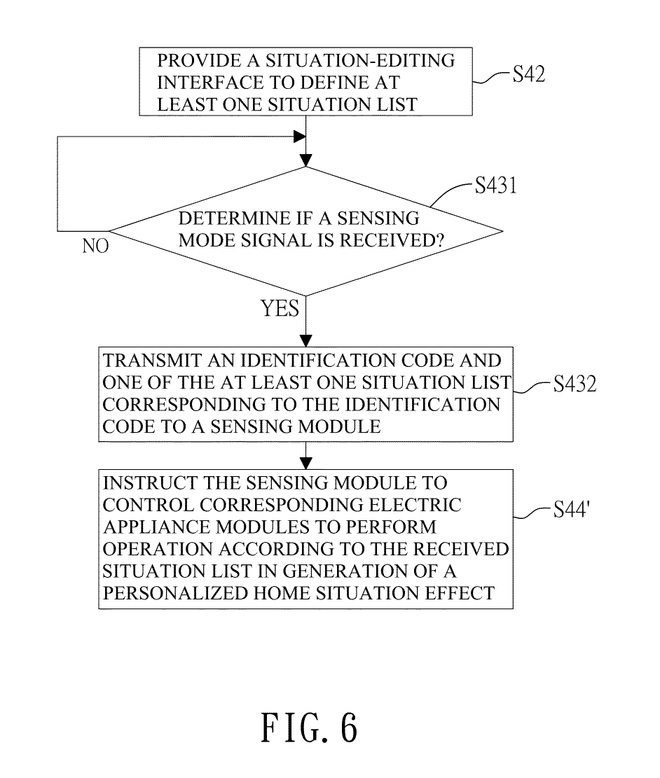

With reference to FIG. 6, if users move to different environments or intend to change the home situation effect, the foregoing step S43 is replaced by the following steps.

Step S431: Determine if a sensing mode signal is received. When the sensing mode signal is not received, resume step S431.

Step S432: Transmit an identification code and one of the at least one situation list corresponding to the identification code to a sensing module.

The foregoing step S44 is replaced by the following step.

Step S44′: Instruct the sensing module to control corresponding electric appliance modules to perform operation according to the received situation list in generation of a personalized home situation effect.

Thus, when users intend to change original home situation effect, the situation control device 10 just needs to be moved close to a corresponding sensing module and determine if the sensing mode signal is received. When the sensing mode signal is received, the identification code and the situation list corresponding to the identification code are transmitted to the corresponding sensing module such that the corresponding sensing module further control corresponding electric appliance modules to perform operation in generation of a personalized home situation effect. Given the situation control device 10, the situation control device 10 can be used to generate an editable and personalized home situation effect in a portable and less environmentally restrictive manner, thereby enhancing operational convenience and flexibility upon delivering the personalized home situation effect.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A personalized home situation control method performed by a situation control device to vary operating states of multiple electric appliance modules capable of changing atmosphere of condition in an environment through at least one wireless communication protocol, the method comprising steps of:
receiving wireless signals transmitted from the multiple electric appliance modules;
providing a situation-editing interface for users to select information represented by the wireless signals from the situation-editing interface to define at least one situation list, wherein each one of the at least one situation list has a preset identification code;
determining if a situation mode execution command is received; and
wirelessly transmitting control signals to corresponding electric appliance modules for the corresponding electric appliance modules to perform corresponding operation according to contents of the at least one situation list in generation of a personalized home situation effect.

2. The method as claimed in claim 1, further comprising steps of:
determining if a sensing mode signal is received;
transmitting an identification code and one of the at least one situation list corresponding to the identification code to a sensing module; and
instructing the sensing module to control corresponding electric appliance modules to perform operation according to the received situation list in generation of a personalized home situation effect.

3. A personalized home situation control system, comprising:
a situation control device having:
a first wireless module;
a second wireless module; and
an operation interface serving for multiple users to define multiple personalized situation lists and identification codes corresponding to the personalized situation lists, and wirelessly communicating with an remote equipment for data exchange respectively through the first wireless module and the second wireless module;
at least one repeating device with each one of the at least one repeating device having:
a third wireless module;
at least signal input terminal; and
at least one signal output terminal with each one of the at least one signal output terminal electrically connected to an electric appliance module capable of changing atmosphere in an environment and wirelessly connected to the first wireless module of the situation control device through the third wireless module;
at least one sensing device with each one of the at least one sensing device having:
a fourth wireless module serving for the sensing device to transmit a sensing mode signal through the fourth wireless module to the second wireless module of the situation control device; and
a fifth wireless module serving for the sensing device to wirelessly connect to the third wireless module of a corresponding repeating device through the fifth wireless module.

4. The system as claimed in claim 3, wherein the situation control device has:
a housing;
a processor mounted inside the housing;
a power supply module mounted inside the housing and electrically connected to the processor;
a storage module mounted inside the housing;
an input module mounted on the housing and electrically connected to the processor;
a display module mounted on the housing and electrically connected to the processor;
a biometric information acquisition module mounted on the housing and electrically connected to the processor; and
a solar energy module mounted on the housing and electrically connected to the processor and the power supply module.

5. The system as claimed in claim 4, wherein the biometric information acquisition module receives biometric information of the multiple users and stores the biometric information in the storage module for information security and confidentiality.

6. The system as claimed in claim 5, wherein
each one of the at least one electric appliance module has:
an electric appliance electrically connected to the signal output terminal of a corresponding repeating device; and
a switch module electrically connected to the signal input terminal of the corresponding repeating device;
wherein when one of the multiple users inputs a situation execution mode command on the operation interface of the situation control device, one of the at least one repeating device wirelessly receives a control signal transmitted from the situation control device to change an operating condition of the electric appliance connected to the repeating device.

7. The system as claimed in claim 6, further comprising a mobile device, wherein the mobile device has:
a first power port;
a battery module electrically connected to the first power port;
wherein the power supply module of the situation control device is electrically connected to the first power port of the mobile device through a second power port.

8. The system as claimed in claim 3, wherein
the first wireless module of the situation control device wirelessly communicates with the third wireless module of each one of the at least one repeating device through a first wireless communication protocol for data exchange;
the second wireless module of the situation control device wirelessly communicates with the fourth wireless module of each one of the at least one sensing device through a second wireless communication protocol for data exchange; and
the third wireless module of each one of the at least one repeating device wirelessly communicates with the fifth wireless module of a corresponding sensing device through the first wireless communication protocol for data exchange.

9. The system as claimed in claim 4, wherein
the first wireless module of the situation control device wirelessly communicates with the third wireless module of each one of the at least one repeating device through a first wireless communication protocol for data exchange;
the second wireless module of the situation control device wirelessly communicates with the fourth wireless module of each one of the at least one sensing device through a second wireless communication protocol for data exchange; and
the third wireless module of each one of the at least one repeating device wirelessly communicates with the fifth wireless module of a corresponding sensing device through the first wireless communication protocol for data exchange.

10. The system as claimed in claim 5, wherein
the first wireless module of the situation control device wirelessly communicates with the third wireless module of each one of the at least one repeating device through a first wireless communication protocol for data exchange;
the second wireless module of the situation control device wirelessly communicates with the fourth wireless module of each one of the at least one sensing device through a second wireless communication protocol for data exchange; and
the third wireless module of each one of the at least one repeating device wirelessly communicates with the fifth wireless module of a corresponding sensing device through the first wireless communication protocol for data exchange.

11. The system as claimed in claim 6, wherein
the first wireless module of the situation control device wirelessly communicates with the third wireless module of each one of the at least one repeating device through a first wireless communication protocol for data exchange;
the second wireless module of the situation control device wirelessly communicates with the fourth wireless module of each one of the at least one sensing device through a second wireless communication protocol for data exchange; and
the third wireless module of each one of the at least one repeating device wirelessly communicates with the fifth wireless module of a corresponding sensing device through the first wireless communication protocol for data exchange.

12. The system as claimed in claim 7, wherein
the first wireless module of the situation control device wirelessly communicates with the third wireless module of each one of the at least one repeating device through a first wireless communication protocol for data exchange;
the second wireless module of the situation control device wirelessly communicates with the fourth wireless module of each one of the at least one sensing device through a second wireless communication protocol for data exchange; and
the third wireless module of each one of the at least one repeating device wirelessly communicates with the fifth wireless module of a corresponding sensing device through the first wireless communication protocol for data exchange.

13. The system as claimed in claim 8, wherein the first wireless communication protocol is the ZigBee protocol, and the second wireless communication protocol is the RFID protocol.

14. The system as claimed in claim 9, wherein the first wireless communication protocol is the ZigBee protocol, and the second wireless communication protocol is the RFID protocol.

15. The system as claimed in claim 10, wherein the first wireless communication protocol is the ZigBee protocol, and the second wireless communication protocol is the RFID protocol.

16. The system as claimed in claim 11, wherein the first wireless communication protocol is the ZigBee protocol, and the second wireless communication protocol is the RFID protocol.

17. The system as claimed in claim 12, wherein the first wireless communication protocol is the ZigBee protocol, and the second wireless communication protocol is the RFID protocol.

18. The system as claimed in claim 13, wherein the electric appliance is one of a lamp, an air conditioner, a television, a media player, an amplifier equipment and an electric curtain.

19. The system as claimed in claim 14, wherein the electric appliance is one of a lamp, an air conditioner, a television, a media player, an amplifier equipment and an electric curtain.

20. The system as claimed in claim 15, wherein the electric appliance is one of a lamp, an air conditioner, a television, a media player, an amplifier equipment and an electric curtain.

21. The system as claimed in claim 16, wherein the electric appliance is one of a lamp, an air conditioner, a television, a media player, an amplifier equipment and an electric curtain.

22. The system as claimed in claim 17, wherein the electric appliance is one of a lamp, an air conditioner, a television, a media player, an amplifier equipment and an electric curtain.
